(19) United States
(12) Patent Application Publication
(10) Pub. No.: US 2011/0111297 A1
(43) Pub. Date: May 12, 2011

(54) NONAQUEOUS ELECTROLYTE SECONDARY BATTERY

(76) Inventors: Toshitada SATO, Osaka (JP); Kozo Watanabe, Osaka (JP)

(21) Appl. No.: 12/888,168

(22) Filed: Sep. 22, 2010

(30) Foreign Application Priority Data
Nov. 9, 2009 (JP) 2009-256264

(51) Int. Cl. H01M 4/525; H01M 4/131; H01M 4/1391; H01M 4/13

(52) U.S. Cl. 429/220; 429/221; 429/223; 429/224; 429/225; 429/229; 429/231.3; 429/231.5; 429/231.6; 429/231.95

(57) ABSTRACT

A nonaqueous electrolyte secondary battery including: an electrode group which includes a positive electrode containing lithium-containing composite oxide, a negative electrode capable of inserting and extracting lithium ions, and a porous insulator interposed between the positive electrode and the negative electrode, and is sealed in a battery case together with a nonaqueous electrolyte, wherein the porous insulator has a Gurley number of 100 sec/100 ml to 1000 sec/100 ml, both inclusive, and an average pore diameter of 0.05 μm to 0.15 μm, both inclusive.

### CROSS-REFERENCE TO RELATED APPLICATION

This application claims priority to Japanese Patent Application No. 2009-256264 filed on Nov. 9, 2009, the disclosure of which including the specification, the drawings, and the claims is hereby incorporated by reference in its entirety.

### BACKGROUND

The present disclosure relates to nonaqueous electrolyte secondary batteries, particularly to nonaqueous electrolyte secondary batteries including an electrode group which includes a positive electrode containing lithium-containing composite oxide, a negative electrode capable of inserting and extracting lithium ions, and a porous insulator interposed between the positive electrode and the negative electrode, and is sealed in a battery case together with a nonaqueous electrolyte.

Compact and lightweight secondary batteries which are capable of quick charge, and high current discharge have recently been in demand in the fields of electric vehicles from the viewpoint of environmental issues, and large electric tools for the purpose of switching AC power to DC power. A typical example of such batteries is a nonaqueous electrolyte secondary battery. The nonaqueous electrolyte secondary battery includes a lithium intercalation compound as a negative material prepared by inserting an active material such as lithium metal, lithium alloy, etc., or lithium ions into carbon (graphite) as a host substance capable of inserting and extracting lithium ions, and aprotic organic solvent dissolving lithium salt such as LiClO₄, LiPF₆, etc. as an electrolytic solution.

In general, the nonaqueous electrolyte secondary battery includes a negative electrode including a negative electrode current collector carrying the above-described negative material, a positive electrode including a positive electrode current collector carrying a positive electrode active material capable of reversibly electrochemically reacting with lithium ions, like lithium cobalt composite oxide, and a porous insulator (a separator) which keeps an electrolytic solution, and is interposed between the negative and positive electrodes to prevent a short circuit between the negative and positive electrodes.

The positive and negative electrodes which are in the shape of a sheet or foil is laminated or wound into spiral with the porous insulator interposed therebetween to constitute a power generating component. The power generating component is contained in a battery case made of metal such as stainless steel, nickel-plated iron, aluminum, etc. Then, the electrolytic solution is injected in the battery case, and an opening end of the battery case is sealed with a lid. Thus, the nonaqueous electrolyte secondary battery is provided. The metallic battery case may be replaced with an aluminum laminate film as an outer jacket.

The nonaqueous electrolyte secondary battery (hereinafter simply referred to as a “battery”) has a problem in that a metallic foreign particle, if enters the battery, may connect the positive and negative electrodes to cause a short circuit. When a large metallic foreign particle enters, it would break the separator shortly. Even when a small metallic foreign particle enters, it may dissolve into the electrolyte, and then deposit on the negative electrode through a battery reaction to grow toward the positive electrode, thereby causing the short circuit.

More specifically, an impurity which enters the positive electrode during the fabrication thereof may generally include metallic foreign particles. The metallic foreign particles may enter the active material or the conductive agent during synthesis thereof, or may be left in the positive electrode due to chipping and wearing during the fabrication process. Examples of the metallic foreign particles include iron, nickel, copper, stainless steel, brass, etc. These metallic foreign particles are dissolved at an operating potential of the positive electrode.

In a general nonaqueous electrolyte secondary battery, the positive and negative electrodes in the electrode group are arranged very close to each other with the porous insulator interposed therebetween. When the negative electrode is in a charged state (and is at a sufficiently low potential), ions of a dissolved metallic foreign particle are immediately deposited on the surface of the negative electrode, and finally reaches the positive electrode, thereby causing an internal short circuit.

Since the battery case and the current collector are made of metal, metal chippings as the metallic foreign particles may possibly enter the battery during the fabrication. Alternatively, metallic foreign particles contained in the active material or the conductive agent, and metallic foreign particles derived from a fabrication apparatus may possibly enter the battery. Therefore, the entry of the metallic foreign particles is inevitable.

### SUMMARY

The present disclosure provides a nonaqueous electrolyte secondary battery which is free from the problem of the short circuit described above, and can be used safely.

For this purpose, the disclosed nonaqueous electrolyte secondary battery includes an electrode group which includes a positive electrode containing lithium-containing composite oxide, a negative electrode capable of inserting and extracting lithium ions, and a porous insulator interposed between the positive and negative electrodes, and is sealed in a battery case together with a nonaqueous electrolyte, wherein the porous insulator has a Gurley number of 100 sec/100 ml to 1000 sec/100 ml, both inclusive, and an average pore diameter of 0.05 μm to 0.15 μm, both inclusive.

### BRIEF DESCRIPTION OF THE DRAWING

FIG. 1 is a cross-sectional view of a nonaqueous electrolyte secondary battery according to an embodiment.

### DETAILED DESCRIPTION

### DEFINITION

In the present specification, the term composite oxide refers to oxide which contains at least two kinds of metal ions, and does not contain oxo acid ions in view of the molecular structure. The term oxide refers to a substance containing oxygen having an oxidation number of −2. Therefore, LiFePO₄ is also lithium-containing composite oxide.

### Embodiment

Details of how the present disclosure has been achieved will be described before the description of the embodiments.

In order to increase the capacity of the nonaqueous electrolyte secondary battery, a positive electrode active material and a negative electrode active material can be contained in the battery at high density, or an alloy material containing silicon or tin capable of inserting a larger amount of lithium than graphite can be used as the negative electrode. However, the alloy material used as the negative electrode is disadvantageous in that the capacity of the first discharge is low relative to the capacity of the first charge (irreversible capacity is high) as compared with graphite. To solve this problem, Japanese Patent Publication No. 2005-085633 proposes addition of lithium in advance to the negative electrode to compensate for a shortage of lithium.

In an electrode group including the negative electrode to which lithium has been added in advance, and a general positive electrode made of lithium cobalt composite oxide, a potential difference is applied between the positive and negative electrodes immediately after the injection of the electrolytic solution. Metallic foreign particles which enter the positive electrode as impurities (e.g., metallic particles containing iron, nickel, copper, etc.) is immediately dissolved, and is deposited on the surface of the negative electrode having a lower potential. Once the deposition occurs on a portion of the negative electrode, metallic ions derived from the metallic foreign particle are concentrated on the portion, and the deposit (metal) grows toward the positive electrode. As a result, a metallic conductive material is formed between the positive electrode and the negative electrode, thereby causing an internal short circuit. In the above-described configuration, the metallic foreign particle easily causes the short circuit, even if its amount is very small, thereby significantly increasing the rate of voltage failure due to the short circuit.

Even if lithium has not been added in advance to the negative electrode, a deposit derived from the metallic foreign particle may grow from the negative electrode to the positive electrode during charge/discharge, thereby causing the short circuit.

The entry of the metallic foreign particles is inevitable. Therefore, the inventors have made various examinations for the purpose of preventing the short circuit with the presence of the metallic foreign particles, and have achieved the disclosed nonaqueous electrolyte secondary battery.

Embodiments of the present disclosure will be described in detail below. The present disclosure is not limited to these embodiments.

A lithium ion battery according to the embodiment includes a porous insulator used as a separator, and the porous insulator has a Gurley number of 100 sec/100 ml to 1000 sec/100 ml, both inclusive, and an average pore diameter of 0.05 μm to 0.15 μm, both inclusive. The Gurley number is measured by a method of JIS P8117. The average pore diameter may be measured by any method, e.g., mercury intrusion. In the mercury intrusion, mercury is allowed to intrude into the porous insulator to measure the pore diameter based on an intrusion pressure and an amount of intruded mercury. The pore diameter is calculated by Washburn's formula: Pr=−2γ cos θ, wherein P is pressure, r is a pore radius, γ is surface tension of mercury, and θ is an angle of contact between mercury and a sample.

With use of the above-described porous insulator, the deposit on the negative electrode surface derived from the metallic foreign particle is presumably less likely to penetrate through the pores of the porous insulator. Since the deposit grows along an inner wall surface of the pores in the porous insulator, the growth of the deposit from the negative electrode surface to the positive electrode surface can presumably be prevented by increasing a distance between the pores in the porous insulator, and connecting the multiple small pores within the porous insulator. In view of this mechanism, the deposit derived from the metallic foreign particle is less likely to reach the positive electrode surface from the negative electrode surface if the Gurley number is larger, and the average pore diameter is smaller. However, when the Gurley number is too large, or the average pore diameter is too small, ion permeability in the porous insulator is reduced, and a sufficient amount of the electrolytic solution cannot be supplied in high current discharge. This is disadvantageous to the high current discharge.

According to the embodiment, the positive electrode contains lithium-containing composite oxide as an active material, and the composite oxide preferably contains at least one metallic element selected from the group consisting of Na, Mg, Sc, Y, Mn, Fe, Co, Ni, Cu, Zn, Al, Cr, Pb, Sb, and B.

In particular, a ratio between a total molar amount x of lithium contained in the positive electrode and the negative electrode, and a total molar amount y of the metallic element except for lithium contained in the lithium-containing composite oxide (x/y) is preferably higher than 1.05. This configuration is employed when irreversible capacity of the negative electrode active material is compensated by externally adding lithium, thereby increasing the battery capacity. The addition of lithium can be performed by vapor-depositing lithium on the negative electrode before constituting the electrode group, or bringing metal lithium into contact with the surface of the negative electrode, or a portion of the negative electrode. In this case, however, a large potential difference is applied between the positive and negative electrodes immediately after introducing the electrolytic solution into the electrode group. Thus, the metallic foreign particle contained in the positive electrode is immediately dissolved, and the deposit is immediately generated on the negative electrode surface. The present disclosure is significantly effective against such phenomena.

If the ratio x/y is higher than 1.5, the negative electrode is kept expanded due to a large amount of lithium contained in the negative electrode. Accordingly, the electrolytic solution is less likely to penetrate into the negative electrode, thereby reducing the charge/discharge cycle characteristic. Therefore, the ratio x/y is preferably not higher than 1.5. The ratio x/y is more preferably not higher than 1.25 to prevent reduction in thermal stability due to increase in amount of lithium which remains in the negative electrode, and does not contribute to the charge/discharge.

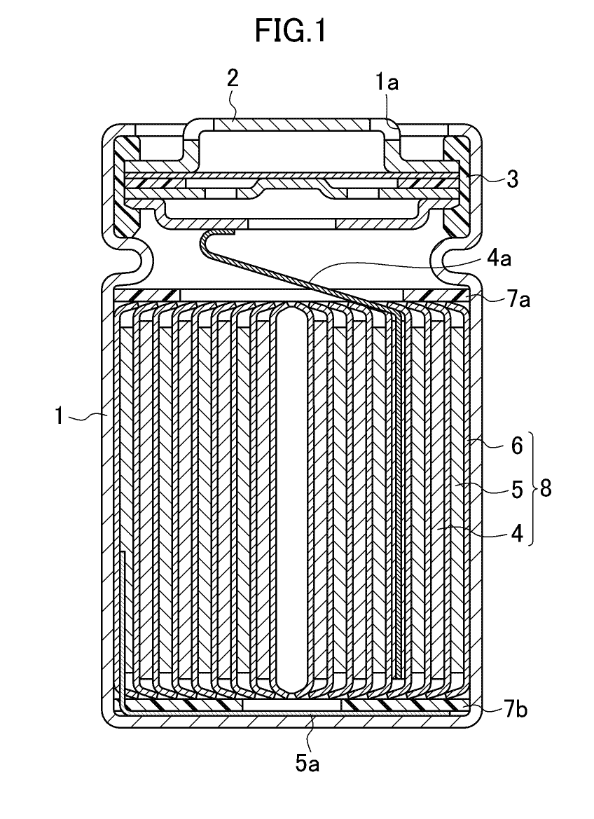

A lithium ion secondary battery will be described with reference to FIG. 1 as an example of a nonaqueous electrolyte secondary battery of a first embodiment.

FIG. 1 is a schematic vertical cross-sectional view illustrating the structure of the nonaqueous electrolyte secondary battery of the first embodiment.

The nonaqueous electrolyte secondary battery of this embodiment includes, as shown in FIG. 1, a battery case 1 made of stainless steel, for example, and an electrode group 8 contained in the battery case 1.

The battery case 1 has an opening 1a at an upper end thereof. A sealing plate 2 is crimped onto the opening 1a with a gasket 3 interposed therebetween to close the opening 1a.

The electrode group 8 includes a positive electrode 4, a negative electrode 5, and a separator (a porous insulator) 6 made of polyethylene, for example. The positive electrode 4 and the negative electrode 5 are wound into spiral with the separator 6 interposed therebetween. An upper insulator 7a is arranged above the electrode group 8a, and a lower insulator 7b is arranged below the electrode group 8.

An end of an aluminum positive electrode lead 4a is attached to the positive electrode 4, and the other end of the positive electrode lead 4a is attached to the sealing plate 2 which also functions as a positive electrode terminal. An end of a nickel negative electrode lead 5a is connected to the negative electrode 5, and the other end of the negative electrode lead 5a is connected to the battery case 1 which also functions as a negative electrode terminal.

The positive electrode 4 includes a positive electrode current collector and a positive electrode material mixture layer. The positive electrode current collector is a conductive plate mainly made of aluminum. The positive electrode material mixture layer is formed on each surface of the positive electrode current collector, and contains a positive electrode active material (e.g., lithium composite oxide), and a binder. Further, the positive electrode material mixture layer preferably contains a conductive agent.

The negative electrode 5 includes a negative electrode current collector and a negative electrode material mixture layer. The negative electrode current collector is a conductive plate. The negative electrode material mixture layer is formed on each surface of the negative electrode current collector, and contains a negative electrode active material. Further, the negative electrode material mixture layer preferably contains a binder.

The separator 6 is interposed between the positive electrode 4 and the negative electrode 5 to prevent direct contact between the positive electrode 4 and the negative electrode 5.

The positive electrode 4, the negative electrode 5, the separator 6, and the nonaqueous electrolyte constituting the nonaqueous electrolyte secondary battery of this embodiment will be described in detail below.

First, the positive electrode will be described in detail.

### —Positive Electrode—

The positive electrode current collector and the positive electrode material mixture layer constituting the positive electrode 4 will be described.

A long, porous or nonporous conductive substrate is used as the positive electrode current collector. The positive electrode current collector is made of metallic foil mainly made of aluminum. Although not particularly limited, the positive electrode current collector preferably has a thickness of 1 μm to 500 μm, both inclusive, more preferably 10 μm to 20 μm, both inclusive. With the thickness of the positive electrode current collector controlled within the above-described range, the positive electrode 4 can be reduced in weight without reducing its strength.

The positive electrode active material, the binder, and the conductive agent contained in the positive electrode material mixture layer will be described.

### <Positive Electrode Active Material>

A preferable positive electrode active material is lithium-containing composite oxide, such as LiCoO₂, LiNiO₂, LiMnO₂, LiCOₓNi₁₋ₓO₂, LiCOₓM₁₋ₓO₂, LiNiₓM₁₋ₓO₂, LiNi_{1/3}CO_{1/3}Mn_{1/3}O₂, LiMn₂O₄, LiMnMO₄, LiMePO₄, Li₂MePO₄F (wherein M is at least one element selected from Na, Mg, Sc, Y, Mn, Fe, Co, Ni, Cu, Zn, Al, Cr, Pb, Sb and B, 0<x<1, and Me is a metallic element containing at least one selected from Fe, Mn, Co, and Ni). In these lithium-containing compounds, one of the elements may be substituted with a different element. The positive electrode active material may be surface-treated with metal oxide, lithium oxide, a conductive agent, etc., by hydrophobization, for example.

The positive electrode active material preferably has an average pore diameter of 5 μm to 20 μm, both inclusive. When the average particle diameter of the positive electrode active material is smaller than 5 μm, a surface area of the active material particles significantly increases, and a significantly large amount of binder is required to obtain adhesion strength which allows easy handling of the positive electrode. This reduces the amount of the active material per electrode, thereby reducing capacity. When the average particle diameter is larger than 20 μm, streaks are easily formed when the positive electrode material mixture slurry is applied to the positive electrode current collector.

### <Binder>

Examples of the binder include, for example, PVDF, polytetrafluoroethylene, polyethylene, polypropylene, aramid resin, polyamide, polyimide, polyamide imide, polyacrylonitrile, polyacrylic acid, methyl polyacrylate, ethyl polyacrylate, hexyl polyacrylate, polymethacrylic acid, methyl polymethacrylate, ethyl polymethacrylate, hexyl polymethacrylate, polyvinyl acetate, polyvinyl pyrrolidone, polyether, polyether sulfone, hexafluoropolypropylene, styrene butadiene rubber, carboxymethyl cellulose, etc., and a copolymer or a mixture of two or more materials selected from tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene.

Among the above-listed examples of the binder, PVDF and a derivative thereof are particularly chemically stable in the nonaqueous electrolyte secondary battery, and is capable of sufficiently binding the positive electrode material mixture layer and the positive electrode current collector, and binding the positive electrode active material, the binder, and the conductive agent constituting the positive electrode material mixture layer, thereby providing good charge/discharge cycle characteristic and discharge characteristic. Therefore, PVDF or its derivative is preferably used as the binder of the present embodiment. PVDF and its derivative are preferable also for their low costs. When the PVDF is used as the binder contained in the positive electrode, PVDF may be dissolved in N-methylpyrrolidone, or powder PVDF may be dissolved in a positive electrode material mixture slurry.

### <Conductive Agent>

Examples of the conductive agent include, for example, graphites such as natural graphite, artificial graphite, etc., carbon blacks such as acetylene black (AB), Ketchen black, channel black, furnace black, lamp black, thermal black, etc., conductive fibers such as carbon fiber, metal fiber, etc., metal powders such as carbon fluoride, aluminum, etc., conductive whiskers such as zinc oxide, potassium titanate, etc., conductive metal oxide such as titanium oxide etc., conductive organic material such as a phenylene derivative etc.

The negative electrode will be described in detail below.

### —Negative Electrode—

The negative electrode current collector and the negative electrode material mixture layer constituting the negative electrode 5 will be described below.

A long, porous or nonporous conductive substrate is used as the negative electrode current collector. The negative electrode current collector is made of, for example, stainless steel, nickel, copper, etc. Although not particularly limited, the negative electrode current collector preferably has a thickness of 1 μm to 500 μm, both inclusive, more preferably 10 μm to 20 μm, both inclusive. With the thickness of the negative electrode current collector controlled within the above-described range, the negative electrode 5 can be reduced in weight without reducing its strength.

The negative electrode material mixture layer preferably contains a binder in addition to the negative electrode active material.

The negative electrode active material contained in the negative electrode material mixture layer will be described below.

### <Negative Electrode Active Material>

A material capable of inserting and extracting lithium ions is used as the negative electrode active material. Examples of the material include, for example, metals, metal fibers, carbon materials, oxides, nitrides, silicon compounds, tin compounds, and various kinds of alloys. Among them, the carbon materials include, for example, various natural graphites, coke, graphitizing carbon, carbon fiber, spherical carbon, various artificial graphites, amorphous carbon, etc.

A simple substance such as silicon (Si), tin (Sn), etc., a silicon compound, and a tin compound are preferably used as the negative electrode active material because they have high capacity density. Examples of the silicon compound include, for example, SiOx (0.05<x<1.95), and a silicon alloy in which Si is partially substituted with at least one element selected from B, Mg, Ni, Ti, Mo, Co, Ca, Cr, Cu, Fe, Mn, Nb, Ta, V, W, Zn, C, N, and Sn, and a silicon solid solution. Examples of the tin compound include, for example, Ni₂Sn₄, Mg₂Sn, SnOₓ (wherein 0<x<2), SnO₂, SnSiO₃, etc. The above-listed negative electrode active materials may be used alone, or in combination of two or more of them.

The silicon, tin, silicon compound, or tin compound may be stacked on the negative electrode current collector in the shape of thin layers to constitute the negative electrode.

The separator will be described in detail below.

### —Separator (Porous Insulator)—

As the separator 6 interposed between the positive electrode 4 and the negative electrode 5, a thin microporous film, woven fabric, nonwoven fabric, etc., having high ion permeability, and predetermined mechanical strength and insulating property can be used. In particular, the separator 6 is preferably made of, for example, polyolefin such as polypropylene, polyethylene, etc. Polyolefin has high durability and shut down function, thereby improving safety of lithium ion secondary batteries.

The separator 6 has a Gurley number of 100 sec/100 ml to 1000 sec/100 ml, both inclusive, and an average pore diameter of 0.05 μm to 0.15 μm, both inclusive. Use of the separator having these properties allows an increased distance between pores of the separator, connection between the multiple small pores within the separator, and an increased total distance of an inner wall surface of the pores. This can prevent a deposit which grows on the negative electrode surface from reaching the positive electrode surface along the inner wall surface of the pores.

The Gurley number is measured by a method of JIS P8117. Specifically, a separator of 50 mm×50 mm is formed, and time (seconds) required for a predetermined amount of air to pass through a pore having a diameter of 28.6 mm (permeation area: 642 mm²) is measured. In this embodiment, the predetermined amount of air is 100 cm³.

The average pore diameter of the separator 6 may be measured by, for example, mercury intrusion.

The separator 6 generally has a thickness of 10 μm to 300 μm, both inclusive, preferably 10 μm to 40 μm, both inclusive. The thickness of the separator 6 is more preferably 15 μm to 30 μm, both inclusive, much more preferably 10 μm to 25 μm, both inclusive. The thin microporous film used as the separator 6 may be a monolayer film made of a single material, or a composite or multilayer film made of a single material, or at least two materials. Porosity of the separator 6 is preferably 30% to 70%, both inclusive, more preferably 35% to 60%, both inclusive. The porosity is the ratio of the volume of the pores relative to the whole volume of the separator.

The nonaqueous electrolyte will be described in detail below.

### —Nonaqueous Electrolyte—

As the nonaqueous electrolyte, a liquid, gelled, or solid nonaqueous electrolyte can be used.

The liquid nonaqueous electrolyte (a nonaqueous electrolytic solution) contains an electrolyte (e.g., lithium salt), and a nonaqueous solvent which dissolves the electrolyte.

The gelled nonaqueous electrolyte contains a nonaqueous electrolyte, and a polymer material which holds the nonaqueous electrolyte. Examples of the polymer material include, for example, polyvinylidene fluoride, polyacrylonitrile, polyethylene oxide, polyvinyl chloride, polyacrylate, polyvinylidene fluoride hexafluoropropylene, etc.

The solid nonaqueous electrolyte contains a polymeric solid electrolyte.

The nonaqueous electrolytic solution will be described in detail below.

A known nonaqueous solvent can be used to dissolve the electrolyte. The nonaqueous solvent is not particularly limited. For example, cyclic carbonate, chain carbonate, cyclic carboxylate, etc. Examples of cyclic carbonate include, for example, propylene carbonate (PC), ethylene carbonate (EC), etc. Examples of chain carbonate includes, for example, diethyl carbonate (DEC), ethylmethyl carbonate (EMC), dimethyl carbonate (DMC), etc. Examples of cyclic carboxylate include, for example, γ-butyrolactone (GBL), γ-valerolactone (GVL), etc. The above-listed nonaqueous solvents may be used alone, or in combination of two or more of them.

Examples of the electrolyte dissolved in the nonaqueous solvent include, for example, LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lower aliphatic lithium carboxylate, LiCl, LiBr, LiI, chloroborane lithium, borates, imidates, etc. Examples of borates include, for example, lithium bis(1,2-benzenediolate(2-)-O,O′)borate, lithium bis(2,3-naphthalenediolate(2-)-O,O′)borate, lithium bis(2,2′-biphenyldiolate(2-)-O,O′)borate, lithium bis(5-fluoro-2-olate-1-benzenesulfonic acid-O,O′)borate, etc. Examples of imidates include, for example, lithium(bis)trifluoromethanesulfonimide((CF₃SO₂)₂NLi), lithium trifluoromethanesulfonic acid nonafluorobutanesulfonimide(LiN(CF₃SO₂)(C₄F₉SO₂)), lithium bis(pentafluoroethanesulfone)imide((C₂F₅SO₂)₂NLi), etc. The above-listed electrolytes may be used alone, or in combination of two or more of them.

The amount of the electrolyte dissolved in the nonaqueous solvent is preferably 0.5 mol/m³ to 2 mol/m³, both inclusive.

In addition to the electrolyte and the nonaqueous solvent, the nonaqueous electrolytic solution may also contain an additive which is decomposed on the negative electrode to form a coating having high lithium ion conductivity, thereby improving charge/discharge efficiency of the battery. Examples of the additive include, for example, vinylene carbonate (VC), 4-methyl vinylene carbonate, 4,5-dimethyl vinylene carbonate, 4-ethyl vinylene carbonate, 4,5-diethyl vinylene carbonate, 4-propyl vinylene carbonate, 4,5-dipropyl vinylene carbonate, 4-phenyl vinylene carbonate, 4,5-diphenyl vinylene carbonate, vinyl ethylene carbonate (VEC), divinyl ethylene carbonate, etc. The above-listed additives may be used alone, or in combination of two or more of them. Among the above-listed additives, at least one selected from the group consisting of vinylene carbonate, vinyl ethylene carbonate, and divinyl ethylene carbonate is particularly preferable. In the above-listed additives, some of hydrogen atoms may be substituted with fluorine atoms.

The nonaqueous electrolytic solution may contain a known benzene derivative which is decomposed to form a coating on the electrode, thereby inactivating the battery in the case of overcharge. Such a benzene derivative preferably has a phenyl group, and a cyclic compound group adjacent to the phenyl group. Examples of the benzene derivative include, for example, cyclohexylbenzene, biphenyl, diphenyl ether, etc. Examples of the cyclic compound group contained in the benzene derivative include, for example, a phenyl group, a cyclic ether group, a cyclic ester group, a cycloalkyl group, a phenoxy group, etc. The above-listed benzene derivatives may be used alone, or in combination of two or more of them. The amount of the benzene derivative contained in the nonaqueous solvent is preferably 10 vol % or lower relative to the whole nonaqueous solvent.

The structure of the nonaqueous electrolyte secondary battery of the present embodiment is not limited to that shown in FIG. 1. For example, the nonaqueous electrolyte secondary battery of the present embodiment is not limited to the cylindrical battery shown in FIG. 1. The nonaqueous electrolyte secondary battery may be a prism-shaped battery, or a high power battery. The electrode group 8 is not limited to an electrode group prepared by winding the positive electrode 4 and the negative electrode 5 with the separator 6 interposed therebetween as shown in FIG. 1. The electrode group 8 may be prepared by stacking the positive and negative electrodes with the separator interposed therebetween.

A method for fabricating a lithium ion secondary battery, which is an example of the nonaqueous electrolyte secondary battery of a first embodiment, will be described in detail with reference to FIG. 1.

Methods for fabricating the positive electrode 4, the negative electrode 5, and the battery will be described below.

### —Method for Fabricating Positive Electrode—

The positive electrode 4 is fabricated in the following manner. First, the positive electrode active material, the binder (e.g., PVDF, a PVDF derivative, or a rubber-based binder is preferable), and the conductive agent are mixed with a liquid ingredient to prepare positive electrode material mixture slurry. Then, the obtained positive electrode material mixture slurry is applied to each surface of the positive electrode current collector made of aluminum foil, and is dried. Then, the positive electrode current collector carrying the dried positive electrode material mixture slurry thereon is rolled (compressed) to form a positive electrode (a positive electrode plate) of a predetermined thickness.

The amount of the binder contained in the positive electrode material mixture slurry is preferably 3.0 vol % to 6.0 vol %, both inclusive, relative to 100 vol % of the positive electrode active material. That is, the amount of the binder contained in the positive electrode material mixture layer is preferably 3.0 vol % to 6.0 vol %, both inclusive, relative to 100 vol % of the positive electrode active material.

### —Method for Fabricating Negative Electrode—

The negative electrode 5 is fabricated in the following manner. First, the negative electrode active material and the binder are mixed with a liquid ingredient to prepare negative electrode material mixture slurry. Then, the obtained negative electrode material mixture slurry is applied to each surface of the negative electrode current collector, and is dried. Then, the negative electrode current collector carrying the dried negative electrode material mixture slurry thereon is rolled to form a negative electrode of a predetermined thickness.

### <Method for Fabricating Battery>

A battery is fabricated in the following manner. First, as shown in FIG. 1, an aluminum positive electrode lead 4a is attached to the positive electrode current collector, and a nickel negative electrode lead 5a is attached to the negative electrode current collector. The positive electrode 4 and the negative electrode 5 are wound into spiral with the separator 6 interposed therebetween to constitute the electrode group 8. Then, an upper insulator 7a is attached to an upper end of the electrode group 8, and a lower insulator 7b is attached to a lower end of the electrode group 8. The negative electrode lead 5a is welded to the battery case 1, and the positive electrode lead 4a is welded to a sealing plate 2 having an internal pressure operated safety valve. Thus, the electrode group 8 is placed in the battery case 1. Then, the nonaqueous electrolytic solution is injected into the battery case 1 under vacuum. An opening end of the battery case 1 is crimped to the sealing plate 2 with a gasket 3 interposed therebetween. Thus, the battery is fabricated.

Examples of the disclosure will be described in detail below.

### Example 1

A method for fabricating Battery 1 of the example will be described in detail below.

### Battery 1

### —Fabrication of Positive Electrode—

First, LiNi_{0.82}CO_{0.15}Al_{0.03}O₂ having an average particle diameter of 10 μm was prepared.

Acetylene black as the conductive agent, a solution prepared by dissolving PVDF as the binder in an N-methylpyrrolidone (NMP) solvent, and LiNi_{0.82}CO_{0.15}Al_{0.03}O₂ as the positive electrode active material were mixed to obtain a positive electrode material mixture slurry. The amounts of acetylene black and PVDF were 4.5 vol % and 4.7 vol % relative to 100 vol % of the positive electrode active material, respectively.

The positive electrode material mixture slurry was applied to each surface of 15 μm thick aluminum foil as the positive electrode current collector, and was dried. Then, the positive electrode current collector carrying the dried positive electrode material mixture slurry on each surface thereof was rolled to form a 0.157 mm thick positive electrode plate. The positive electrode plate was cut into a strip of 57 mm in width, and 564 mm in length to obtain a positive electrode of 0.157 mm in thickness, 57 mm in width, and 564 mm in length. The positive electrode contained 19 g of the positive electrode active material, in which 1.36 g of lithium was contained.

### —Fabrication of Negative Electrode—

To prepare the negative electrode current collector, a thin silicon film was formed by vapor deposition on each roughened surface of 18 μm thick copper foil. The degree of vacuum in a vapor deposition apparatus was controlled to 1.5×10⁻³ Pa, while 25 sccm of oxygen was injected. The vapor deposition was controlled to form a 10 μm thick thin silicon film on each surface. Measurement of an oxygen amount by a combustion method, and measurement of a silicon amount by ICP method showed that the composition of the active material contained in the thin film was SiO_{0.42.}

Lithium was vapor-deposited on the thin silicon film to reduce irreversible capacity. The thickness of the vapor-deposited lithium film was controlled to 3.2 g/m² (corresponding to 6 μm). After the vapor deposition of lithium, the product was handled in dry air atmosphere at a dew point temperature of −30° C.

The obtained plate was cut into a strip of 58.5 mm in width, and 750 mm in length to obtain a negative electrode. The negative electrode contained 0.14 g of lithium.

### —Preparation of Nonaqueous Electrolytic Solution—

To a nonaqueous solvent prepared by mixing ethylene carbonate and dimethyl carbonate in the volume ratio of 1:3.5 wt % of vinylene carbonate was added as an additive for improving charge/discharge efficiency of the battery, and LiPF₆ as an electrolyte was dissolved therein at a molar concentration of 1.4 mol/m³ relative to the nonaqueous solvent. Thus, the nonaqueous electrolytic solution was obtained.

### —Fabrication of Cylindrical Battery—

First, an aluminum positive electrode lead was attached to the positive electrode current collector, and a nickel negative electrode lead was attached to the negative electrode current collector. Then, the positive and negative electrodes were wound with a separator made of porous polyethylene (20 μm in thickness) interposed therebetween to constitute an electrode group. The separator had a Gurley number of 430 sec/100 ml (average), and an average pore diameter of 0.09 μm. ICP analysis was performed to check the amount of lithium contained in the positive and negative electrodes of the electrode group. Regarding a total molar amount of Ni, Co, and Al contained in the positive electrode as 1, a total molar amount of lithium was 1.13. The Gurley number was an average value of five measurements of a single separator sample.

An upper insulator was attached to an upper end of the electrode group, and a lower insulator was attached to a lower end of the electrode group. Then, the negative electrode lead was welded to the battery case, and the positive electrode lead was welded to the sealing plate having an internal pressure operated safety valve. Thus, the electrode group was placed in the battery case 1. Then, the nonaqueous electrolytic solution was injected into the battery case 1 under vacuum. An opening end of the battery case was crimped to the sealing plate with a gasket interposed therebetween. Thus, a battery was obtained. This battery was referred to Battery 1.

### Battery 2

Battery 2 was fabricated in the same manner as Battery 1 except that a separator having a Gurley number of 130 sec/100 ml (average), and an average pore diameter of 0.15 μm was used.

### Battery 3

Battery 3 was fabricated in the same manner as Battery 1 except that a separator having a Gurley number of 440 sec/100 ml (average), and an average pore diameter of 0.05 μm was used.

### Battery 4

Battery 4 was fabricated in the same manner as Battery 1 except that the separator having a Gurley number of 960 sec/100 ml (average), and an average pore diameter of 0.05 μm was used.

Each of Batteries 1-4 had a battery voltage of about 2.8 V immediately after the fabrication. The battery voltage was measured after 48 hours from the fabrication to obtain a failure rate after 48 hours from the fabrication. When a metallic foreign particle contained in the positive electrode is dissolved, and is deposited on the negative electrode to cause an internal short circuit, the battery voltage becomes lower than 2.8 V. In this embodiment, the battery which experienced reduction in battery voltage lower than 2.6 V after 48 hours from the fabrication was regarded as a failed battery, and the number of failed batteries in 50 test batteries was count to obtain the failure rate.

Discharge capacity of Batteries 1-4 was measured in the following manner. Each of Batteries 1-4 was charged to 4.15 V at a constant current of 1.4 A at 25° C., charged to 50 mA at a constant voltage of 4.15 V, and was discharged to 2.0 V at a constant current of 0.56 A to measure the discharge capacity.

Batteries 1-4 were charged in the above-described manner, and were discharged to 2.0 V at a constant current of 5.6 A to measure battery capacity in high rate discharge. Then, regarding the above-described discharge capacity as 100, a rate of the battery capacity in high rate discharge was obtained as a high-rate discharge rate.

Further, a charge/discharge cycle characteristic of each of Batteries 1-4 was evaluated to measure the rate of occurrence of failure after 500 cycles due to an internal short circuit. To evaluate the charge/discharge cycle characteristic, a process of charging the battery to 4.15 V at a constant current of 1.4 A, charging the battery to 50 mA at a constant voltage of 4.15 V, and discharging the battery to 2.0 V at a constant current of 2.8 A at 45° C. was determined as a single cycle. A 30-minute pause was taken between the charge and discharge, and between the discharge and charge.

Batteries of Comparative Examples were fabricated in the following manner.

### Comparative Example 1

### Battery 5

Battery 5 was fabricated in the same manner as Battery 1 except that the separator having a Gurley number of 90 sec/100 ml (average), and an average pore diameter of 0.18 μm was used.

### Battery 6

Battery 6 was fabricated in the same manner as Battery 1 except that the separator having a Gurley number of 1070 sec/100 ml (average), and an average pore diameter of 0.04 μm was used.

### Battery 7

Battery 7 was fabricated in the same manner as Battery 1 except that the separator having a Gurley number of 1100 sec/100 ml (average), and an average pore diameter of 0.12 μm was used.

Batteries 5-7 were evaluated to obtain the failure rate after 48 hours from the fabrication, discharge capacity, the high-rate discharge rate, and the rate of occurrence of failure after 500 cycles in the same manner as the evaluation of Batteries 1-4. The results are shown in Table 1.

TABLE 1

| | | | | | Rate of |
|---|---|---|---|---|---|
| | | Failure rate | | | occurrence |
| | | after 48 | | High-rate | of failure |
| | | hours from | Discharge | discharge | after 500 |
| | | fabrication | capacity | rate | cycles |
| Battery 1 | Example | 0/50 | 3620 | 97% | 0/50 |
| Battery 2 | | 0/50 | 3630 | 99% | 0/50 |
| Battery 3 | | 0/50 | 3590 | 96% | 0/50 |
| Battery 4 | | 0/50 | 3600 | 95% | 0/50 |
| Battery 5 | Compar- | 38/50 | 3610 | 99% | 9/12 |
| Battery 6 | ative | 0/50 | 3580 | 76% | 7/50 |
| Battery 7 | Example | 0/50 | 3570 | 81% | 0/50 |

### Example 2

### Battery 8

A positive electrode plate was fabricated with the same materials and in the same manner as described in Example 1. The positive electrode plate was cut into a strip of 57 mm in width, and 467 mm in length to prepare a positive electrode. The positive electrode contained 15.3 g of the positive electrode active material, in which 1.09 g of lithium was contained.

In the fabrication of a negative electrode, flake-like artificial graphite was ground and classified to obtain graphite having an average particle diameter of about 20 μm. Then, to 100 parts by weight of flake-like artificial graphite as the negative electrode active material, 3 parts by weight of styrene butadiene rubber as a binder, and 100 parts by weight of an aqueous solution containing 1% by weight of carboxymethyl cellulose were mixed to prepare negative electrode material mixture slurry. The negative electrode material mixture slurry was applied to each surface of an 8 μm thick copper foil as a negative electrode current collector, and was dried to form a negative electrode material mixture layer. Then, the negative electrode current collector carrying the dried negative electrode material mixture slurry on each surface thereof was rolled to obtain a 0.156 mm thick negative electrode plate. The negative electrode plate was thermally treated by hot air in nitrogen atmosphere at 190° C. for 8 hours. The negative electrode plate was cut to obtain a negative electrode of 0.156 mm in thickness, 58.5 mm in width, and 750 mm in length. The negative electrode active material was not provided on part of the negative electrode current collector which does not face the positive electrode active material in the electrode group.

Metal lithium of 100 μm in thickness, 50 mm in width, and 50 mm in length was attached to copper foil on a longitudinal end surface of the negative electrode. The metal lithium weighed 0.13 g. A total lithium amount contained in the positive electrode and the negative electrode was 1.22 g. A total molar amount of lithium was 1.12 relative to a total molar amount of Ni, Co, and Al contained in the positive electrode regarded as 1.

The negative electrode and the positive electrode were wound with a polyethylene porous insulator (a separator, 20 μm in thickness) interposed therebetween to constitute the electrode group. The separator had a Gurley number of 430 sec/100 ml (average), and an average pore diameter of 0.09 μm. Battery 8 was fabricated in the same manner as Battery 1 except for these features of the separator.

### Battery 9

Battery 9 was fabricated in the same manner as Battery 8 except that metal lithium was not attached to the negative electrode.

### Comparative Example 2

### Battery 10

Battery 10 was fabricated in the same manner as Battery 8 except that a separator having a Gurley number of 90 sec/100 ml (average), and an average pore diameter of 0.18 μm was used to constitute the electrode group.

### Battery 11

Battery 11 was fabricated in the same manner as Battery 8 except that a separator having a Gurley number of 1070 sec/100 ml (average), and an average pore diameter of 0.04 μm was used to constitute the electrode group.

### Battery 12

Battery 12 was fabricated in the same manner as Battery 8 except that a separator having a Gurley number of 1100 sec/100 ml (average), and an average pore diameter of 0.12 μm was used to constitute the electrode group.

Discharge capacity of Batteries 8 to 12 was measured in the following manner.

At 25° C., each of Batteries 8 to 12 was charged to 4.2 V at a constant current of 1.4 A, charged to 50 mA at a constant voltage of 4.2 V, and then discharged to 2.5 V at a constant current of 0.56 A to measure the capacity as the discharge capacity.

In the same manner as Example 1, Batteries 8 to 12 were evaluated to obtain the high-rate discharge rate, the failure rate after 48 hours from the fabrication, and the rate of occurrence of failure after 500 cycles. The rate of occurrence of failure after 500 cycles was measured with a charge end voltage of 4.2 V, and a discharge end voltage of 2.5 V. The results are shown in Table 2.

TABLE 2

| | | | | | Rate of |
|---|---|---|---|---|---|
| | | Failure rate | | | occurrence |
| | | after 48 | | High-rate | of failure |
| | | hours from | Discharge | discharge | after 500 |
| | | fabrication | capacity | rate | cycles |
| Battery 8 | Example | 0/50 | 3050 | 98% | 0/50 |
| Battery 9 | | 0/50 | 2900 | 97% | 0/50 |
| Battery 10 | Compar- | 27/50 | 3030 | 99% | 18/23 |
| Battery 11 | ative | 0/50 | 3040 | 71% | 4/50 |
| Battery 12 | Example | 0/50 | 3050 | 74% | 0/50 |

Batteries of Examples 1 and 2 and Comparative Examples 1 and 2 will be examined in detail with reference to Tables 1 and 2.

In Batteries 1-4 of Example 1, the failure rate after 48 hours from the fabrication was 0, and the rate of occurrence of failure after 500 cycles due to the short circuit was 0.

The test batteries were disassembled, and cross sections of the negative electrode and the separator were checked. Then, deposits of metallic elements such as Fe, Ni, etc., were found. The deposits had extended from the surface of the negative electrode to the inside of the separator in the shape of curved branches, but had not reached the positive electrode.

In Battery 5 of Comparative Example, more than 90% of the test batteries experienced the short circuit after 48 hours from the fabrication, and after 500 cycles. Analysis of the short-circuited test batteries revealed that needle-like metal deposit had grown on the negative electrode to reach the positive electrode through the separator in a shortest distance. In the test batteries which did not experienced the short circuit after 500 cycles, the deposit had extended into the separator to be close to the positive electrode. In Battery 6 of Comparative Example 1, the failure rate after 48 hours from the fabrication was 0%, but the rate of occurrence of failure after 500 cycles was 14%.

On Batteries 1-4 and Batteries 5-7, ICP analysis was performed to quantify an amount of the metal of the same kind as the deposit contained in the separator and in the electrolytic solution. The analysis showed that every battery contained approximately the same amount of the metal in the electrolytic solution. In either case, the amount of the dissolved metal was approximately equal. However, some batteries experienced the short circuit, and some did not due to different formation of the deposit.

In Batteries 6 and 7, the discharge capacity was almost equal to that of the other batteries, but the high-rate discharge rate was significantly low. A possible reason for the low high-rate discharge rate is that the ion permeability of the separator was too low to feed the electrolyte solution quickly at high-rate current.

Battery 6 showed the higher rate of occurrence of failure after 500 cycles than that of the other batteries and Battery 7. To check the cause of the high rate of occurrence of failure, the batteries which experienced the short circuit after 500 cycles were disassembled.

As a result, metal lithium had penetrated the separator from the surface of the negative electrode to the surface of the positive electrode to cause the short circuit. This is a possible cause of the failure.

In Batteries 8 and 9 of Example 2, the failure rate after 48 hours from the fabrication, and the rate of occurrence of failure after 500 cycles due to the shirt circuit were 0. In Battery 10 of Comparative Example 2, the failure rate after 48 hours from the fabrication, and the rate of occurrence of failure after 500 cycles due to the short circuit were 90%. Battery 11 showed the rate of occurrence of failure after 500 cycles of 8%. These batteries were disassembled and checked, and the deposit formed in a manner similar to that in Example 1 and Comparative Example 1 was observed. Batteries 11 and 12 of Comparative Example 12 showed significantly low high-rate discharge rate like Batteries 6 and 7 of Comparative Example 1.

Battery 9 was lower in discharge capacity than Battery 8 because irreversible capacity of the negative electrode was not compensated. A total molar amount of lithium contained in the positive and negative electrodes of Battery 9 was 1.02 relative to a total molar amount of Ni, Co, and Al contained in the positive electrode regarded as 1.

The total molar amount of lithium contained in the positive and negative electrodes, and the total molar amount of Ni, Co, and Al contained in the positive electrode were measured by disassembling the battery to remove the positive and negative electrodes, removing the electrolytic solution from the positive and negative electrodes, and performing ICP analysis of metals in a qualitative and quantitative manner by a predetermined treatment. When other metals than Ni, Co, and Al are contained in the positive electrode (e.g., Mn, Zn, Cr, Fe, etc.), the total molar amount can be measured by the same method.

According to the present disclosure, the Gurley number and the average pore diameter of the porous insulator are controlled within the predetermined ranges, respectively, thereby allowing prevention of a metal deposit growing on the surface of the negative electrode from reaching the positive electrode, and allowing safe operation of the battery.

As described above, the disclosed nonaqueous electrolyte secondary battery is useful as a power supply for consumer products of increased energy density, a power supply for electric vehicles, and a power supply for large electric tools, etc.

What is claimed is:

1. A nonaqueous electrolyte secondary battery comprising:
an electrode group which includes a positive electrode containing lithium-containing composite oxide, a negative electrode capable of inserting and extracting lithium ions, and a porous insulator interposed between the positive electrode and the negative electrode, and is sealed in a battery case together with a nonaqueous electrolyte, wherein
the porous insulator has a Gurley number of 100 sec/100 ml to 1000 sec/100 ml, both inclusive, and an average pore diameter of 0.05 μm to 0.15 μm, both inclusive.

2. The nonaqueous electrolyte secondary battery of claim 1, wherein
the lithium-containing composite oxide contains at least one metallic element selected from the group consisting of Na, Mg, Sc, Y, Mn, Fe, Co, Ni, Cu, Zn, Al, Cr, Pb, Sb, and B.

3. The nonaqueous electrolyte secondary battery of claim 2, wherein
a ratio between a total molar amount x of lithium contained in the positive electrode and the negative electrode, and a total molar amount y of the metallic element except for lithium contained in the lithium-containing composite oxide (x/y) is higher than 1.05.
